(19) United States
(12) Patent Application Publication
(10) Pub. No.: US 2017/0252965 A1
(43) Pub. Date: Sep. 7, 2017

(54) MOLDED COMPOSITE STRUCTURE AND METHOD OF MOLDING THE COMPOSITE STRUCTURE

(71) Applicant: Caterpillar Inc., Peoria, IL (US)

(72) Inventors: Aaron K. AMSTUTZ, Peoria, IL (US); James T. Beetham, Peoria, IL (US)

(73) Assignee: Caterpillar Inc., Peoria, IL (US)

(21) Appl. No.: 15/060,294

(22) Filed: Mar. 3, 2016

(51) Int. Cl. B29C 65/70; B32B 13/14; B29C 63/02

(52) U.S. Cl. CPC B29C 65/70; B29C 63/02; B32B 13/14; B29K 2101/10

(57) ABSTRACT

A thermoset structural laminate is provided. The thermoset structural laminate includes a fiber-reinforced layer having a first side and a second side opposite the first side, and a cementitious composite layer having a third side and an fourth side opposite the third side. The second side of the fiber-reinforced layer is molded on or over the third side of the cementitious composite layer.

### TECHNICAL FIELD

The present disclosure relates to a molded composite structure and a method of molding the composite structure.

### BACKGROUND

Materials, such as thermoset elastomers, thermoplastics, thermoset plastics and cementitious composites, may be used to form a variety of articles. For example, high modulus compounds such as Macro-Defect-Free (MDF) cements can be used to form various articles. MDF cements can have higher strength than other cementitious composites, but may retain brittle aspects of such cementitious composites. Thermosetting Sheet Molding Compounds (SMC) may also be used to form various articles, including panels and joists. SMCs can have a high glass content, good toughness and very high tensile strength. However, SMCs may exhibit lower shear modulus and compressive strength than MDF cements. When used separately to form articles, MDF cements and SMCs can suffer from the aforementioned drawbacks and may present difficulties in formation of the articles.

U.S. Pat. No. 6,451,231 describes a structural foam used for stiffening parts such as plastic parts. For instance, this patent describes a structural beam made of the foam encased in SMC for a pickup truck bed. According to this patent, the foam could be formulated for in-mold use at elevated temperatures or at ambient temperatures for use with previously molded parts.

### SUMMARY OF THE DISCLOSURE

In one aspect of the present disclosure, a concurrently co-molded thermoset laminate structure is provided. The laminate structure includes a first fiber-reinforced composite layer having a first side and a second side opposite the first side. The laminate structure also includes a second fiber-reinforced composite layer having a third side and a fourth side opposite the third side. The laminate structure further includes a Macro-Defect-Free (MDF) cement layer having a fifth side contacting the second side of the first fiber-reinforced composite layer and a sixth side opposite the fifth side contacting the third side of the second fiber-reinforced composite layer.

In another aspect of the present disclosure, a structural laminate is provided. The structural laminate includes a first fiber-reinforced layer with a first side and a second side opposite the first side. The first fiber-reinforced layer has a tensile strength greater than or equal to 400 MPa. The structural laminate also includes a second fiber-reinforced layer with a third side and a fourth side opposite the third side. The second fiber-reinforced layer has a tensile strength greater than or equal to 400 MPa. The structural laminate further includes a third layer with a fifth side and a sixth side opposite to the fifth side. The third layer is interposed between the first and second fiber-reinforced layers. The third layer has a compressive strength greater than or equal to 200 MPa and a compressive modulus greater than or equal to 30 GPa.

In yet another aspect of the present disclosure, a method of forming a thermoset composite structure is provided. The method includes molding a Macro-Defect-Free (MDF) cement material to form a MDF cement layer. The method also includes molding a first fiber-reinforced prepreg material to form a first fiber-reinforced layer on the MDF cement layer. The first fiber-reinforced layer has a tensile strength greater than or equal to 400 MPa.

Other features and aspects of this disclosure will be apparent from the following description and the accompanying drawings.

### BRIEF DESCRIPTION OF THE DRAWINGS

FIG. 1 is a diagrammatic representation of a thermoset composite structure having a first layer, a second layer, and a third layer, according to one or more embodiments of the present disclosure;

FIG. 2 is a diagrammatic representation of a thermoset composite structure having a first layer, a second layer, a third layer, and elastomeric layer(s) on one or more of the first and second layers according to one or more embodiments of the present disclosure;

FIG. 3 is a diagrammatic representation of a thermoset composite structure having a first layer, a second layer, a third layer, and an elastomeric layer formed between one or more of the first layer and the third layer and the second layer and the third layer according to one or more embodiments of the present disclosure;

FIG. 4 is a diagrammatic representation of two layers of a thermoset composite structure according to one or more embodiments of the present disclosure;

FIG. 5 is a diagrammatic representation of a thermoset composite structure having an elastomeric layer formed on one layer of the composite structure according to one or more embodiments of the present disclosure;

FIG. 6 is a diagrammatic representation of a thermoset composite structure having an elastomeric layer formed between adjacent layers of the composite structure according to one or more embodiments of the present disclosure;

FIG. 7 is a flowchart for a method of forming a composite structure according to one or more embodiments of the present disclosure;

FIG. 8 is a flowchart for a method of co-molding components to form a composite structure according to one or more embodiments of the present disclosure; and

FIG. 9 is a flowchart for a method of sequentially molding components to form a composite structure according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Generally speaking, embodiments of the described subject matter relate to thermoset molding or bonding an organic chemistry-based composite, such as an epoxy, a polyester resin, a fiber-reinforced composite prepreg, or Sheet Molding Compound (SMC), to a water-based cementitious composite, such as Macro-Defect-Free (MDF) cement. Further, resulting composite structures according to the description herein may find applications in or form a part of a utility or telephone pole, a panel, a joist, a beam, decking, a corrugated structure, a cover, and a hood, and other similar items, without limiting the scope of the present disclosure.

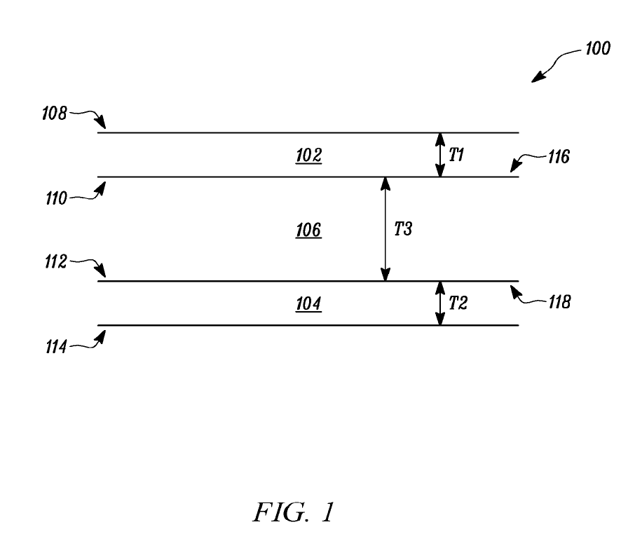

Referring to FIG. 1, a diagrammatic representation of a composite structure 100 is illustrated. The composite structure 100 may be hereinafter interchangeably referred to as “laminate structure,” “structural laminate” or “thermoset composite structure,” without any limitations.

The composite structure 100 includes a first fiber-reinforced layer 102, a second fiber-reinforced layer 104, and a Macro-Defect-Free (MDF) cement layer 106. The first and second fiber-reinforced layers 102, 104 have a thickness “T1” and a thickness “T2”, respectively. Based on the application, for instance, the thickness “T1” may be equal to or different from the thickness “T2.” In one example, one of the first and second fiber-reinforced layers 102, 104 may be thinner than the other.

The first and second fiber-reinforced layers 102, 104 can be embodied as skin layers. Thus, the first fiber-reinforced layer 102 may be hereinafter interchangeably referred to as “a first fiber-reinforced thermosetting Sheet Molding Compound (SMC) layer,” “a skin layer,” or “a first fiber-reinforced layer” formed from a first fiber-reinforced prepreg material. The first fiber-reinforced layer 102 includes a first side 108 and a second side 110 opposite the first side 108. One of the first and second sides 108, 110 of the first fiber-reinforced layer 102 can be on or over the MDF cement layer 106. In the illustrated example, the second side 110 of the first fiber-reinforced layer 102 is in direct contact with a fifth side 116 of the MDF cement layer 106. Further, one of the first and second sides 108, 110 of the first fiber-reinforced layer 102 can form a first external layer of the composite structure 100. That is, the first external layer can be embodied as a free surface or outermost layer of a structure formed by the composite structure 100. In the illustrated embodiment, the first side 108 of the first fiber-reinforced layer 102 is embodied as a first external layer. Alternatively, the first side 108 of the first fiber-reinforced layer 102 has another layer formed thereon.

Further, the second fiber-reinforced layer 104 may be hereinafter interchangeably referred to as “a second fiber-reinforced thermosetting SMC layer,” “a skin layer,” or “a second fiber-reinforced layer” formed from a second fiber-reinforced prepreg material. The second fiber-reinforced layer 104 of the composite structure 100 includes a third side 112 and a fourth side 114 opposite the third side 112. One of the third and fourth sides 112, 114 of the second fiber-reinforced layer 104 can be on or over the MDF cement layer 106. In this example, the third side 112 of the second fiber-reinforced layer 104 is in direct contact with a sixth side 118 of the MDF cement layer 106. Further, one of the third and fourth sides 112, 114 of the second fiber-reinforced layer 104 can form a second external layer of the composite structure 100. That is, the second external layer can also be embodied as a free surface or outermost layer of a structure formed by the composite structure 100. In the illustrated embodiment, the fourth side 114 of the second fiber-reinforced layer 104 is embodied as a second external layer. Alternatively, the fourth side 114 of the second fiber-reinforced layer 104 has another layer formed thereon.

The first fiber-reinforced layer 102, the second fiber-reinforced layer 104, or both may have a tensile strength of 400 MPa or greater. In one example, the first fiber-reinforced layer 102, the second fiber-reinforced layer 104, or both may have a tensile strength of 300 MPa or greater. In another example, the tensile strength of one or both of the first fiber-reinforced layer 102 and the second fiber-reinforced layer 104 may lie at or between 300 MPa and 400 MPa.

Further, a material of the first fiber-reinforced layer 102 may be the same as, similar to, or different from the second fiber-reinforced layer 104, based on the type of application, for instance. In one example, the first and/or second fiber-reinforced layers 102, 104 may include an organic resin. In one example, the first and/or second fiber-reinforced layers 102, 104 may include a heat-cured thermoset plastic as the matrix material. The first and second fiber-reinforced layers 102, 104 may be embodied as Sheet Molding Compound (SMC) layers. In this regard, it should be noted that SMC material used to form the SMC layers may be based on polyester or vinyl-ester chemistry. Alternatively, the first and/or second fiber-reinforced layers 102, 104 may include an organic composite, such as an epoxy, a polyester resin, or other thermoset resin fiber-reinforced composite prepreg. Alternatively, the first and/or second fiber-reinforced layers 102, 104 may include an organic composite based on elastomers that may be filled with continuous and/or discontinuous fibers, for instance, to provide sufficient tensile strength. The term “prepreg” referred to herein relates to a reinforcing fabric which has been pre-impregnated with a resin system. In one example, the first and/or second fiber-reinforced layers 102, 104 may include glass fibers as reinforcement fibers. In another example, the first and/or second fiber-reinforced layers 102, 104 may include carbon fibers as reinforcement fibers. In another example, the first and/or second fiber-reinforced layers 102, 104 may include metal wires or cords as reinforcement elements. Other high tenacity fibers may be used with or in place of glass or carbon fibers where specific properties are targeted.

The MDF cement layer 106 can be embodied as a core layer, and may be interchangeably referred to as “a third layer,” “a core layer,” or “a cementitious composite layer.” The MDF cement layer 106 can be sandwiched or interposed between the first and second fiber-reinforced layers 102, 104. As discussed earlier, the MDF cement layer 106 includes the fifth side 116 and the sixth side 118 opposite the fifth side 116. The fifth side 116 can be on or over the second side 110 of the first fiber-reinforced layer 102, and the sixth side 118 can be on or over the third side 112 of the second fiber-reinforced layer 104. For example, the fifth side 116 can directly contact the second side 110 of the first fiber-reinforced layer 102. Likewise, the sixth side 118 can directly contact the third side 112 of the second fiber-reinforced layer 104. Further, the MDF cement layer 106 has a thickness “T3.” The thickness “T3” may be different from the thicknesses “T1,” “T2” of the first fiber-reinforced layer 102 and the second fiber-reinforced layer 104, respectively. In various examples, one or both of the thicknesses “T1,” “T2” may be less than the thickness “T3.”

The MDF cement layer 106 may have a compressive strength greater than or equal to 200 MPa and a compressive modulus greater than or equal to 30 GPa. It should be noted that the MDF cement layer 106 may be free or substantially free of any reinforcing fibers. Further, the MDF cement layer 106 may be free of porosity or substantially free of porosity.

The MDF cement can be any suitable MDF cement. Accordingly, the MDF cement can include a cement material, water, and one or more polymers. Further, the MDF cement can be made using one or more suitable processes. For example, the cement material, water and the polymers can be pre-mixed, and then subjected to shear mixing and/or calendaring on roll mills. Further, the MDF cement can be formulated to bond to a skin layer or an intervening elastomeric layer, for instance, without use of an additional adhesive. MDF cements can have a high viscosity in uncured state, for example, equal to or above 10,000,000 centipoise or 30 Mooney Units as measured on a Mooney Viscometer. Alternatively, the MDF cement layer 106 may include another water-based material that is substantially free of porosity.

The composite structure 100 may be embodied as a concurrently co-molded thermoset laminate structure or a concurrently co-molded thermoset composite structure. In such an example, the MDF cement layer 106 and one or more of the first fiber-reinforced layer 102 and the second fiber-reinforced layer 104 are concurrently co-molded to form the composite structure 100. More particularly, a MDF cement material and one or more of a first fiber-reinforced material and a second fiber-reinforced material may be co-molded to form the first fiber-reinforced layer 102 on or over the MDF cement layer 106 and/or the second fiber-reinforced layer 104 on or over the MDF cement layer 106. The MDF cement layer 106 and one or more of the first fiber-reinforced layer 102 and the second fiber-reinforced layer 104 may be concurrently co-molded at temperatures between about 70° C. and 150° C., for instance.

In another example, the composite structure 100 may be sequentially molded, for instance, in light of different shrink rates for the materials. In such an example, the MDF cement layer 106 may be molded. Subsequently, one or more of the first fiber-reinforced layer 102 and the second fiber-reinforced layer 104 may be over-molded on or over the MDF cement layer 106. Alternatively, the first fiber-reinforced layer 102 may be over-molded on or over the MDF cement layer 106, followed by the second fiber-reinforced layer 104 being over-molded on or over the MDF cement layer 106. Thus, the first and second fiber-reinforced layers 102, 104 may be concurrently over-molded on or over the MDF cement layer 106 after the MDF cement layer 106 is formed. In yet another example, one of the first and second fiber-reinforced layers 102, 104 can be concurrently co-molded with the MDF cement layer 106, followed by over-molding the other of the first and second fiber-reinforced layers on or over an opposite side of the MDF cement layer 106. In such an example, the MDF cement material and one of the first fiber-reinforced material or the second fiber-reinforced material may be co-molded to form the first fiber-reinforced layer 102 or the second fiber-reinforced layer 104 on or over the MDF cement layer 106. In some situations, an adhesive may be used to bond one or more of the first and second fiber-reinforced layers 102, 104 with the MDF cement layer 106 of the composite structure 100.

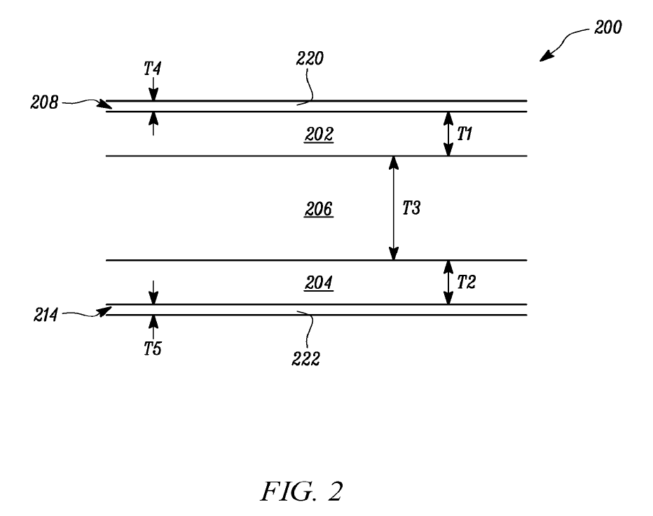

Referring to FIG. 2, a diagrammatic representation of a composite structure 200 is shown. The composite structure 200 can include one or more elastomeric layers. More particularly, the composite structure 200 is illustrated as including a first elastomeric layer 220 and a second elastomeric layer 222. However, to be clear, in one or more embodiments only one of the first elastomeric layer 220 and the second elastomeric layer 222 may be provided.

The first elastomeric layer 220 is located on a first side 208 of a first fiber-reinforced layer 202. A thickness “T4” of the first elastomeric layer 220 may be less than a thickness “T1” of the first fiber-reinforced layer 202 and a thickness “T3” of a MDF cement layer 206. Further, the second elastomeric layer 222 is located on a fourth side 214 of a second fiber-reinforced layer 204. A thickness “T5” of the second elastomeric layer 222 may be less than a thickness “T2” of the second fiber-reinforced layer 204 and the thickness “T3” of the MDF cement layer 206. Also, the thickness “T4” of the first elastomeric layer 220 may be equal to or different than the thickness “T5” of the second elastomeric layer 222.

The first and second elastomeric layers 220, 222 may be embodied as relatively thin layers of a flexible material, such as rubber or polyurethanes. Further, the first and second elastomeric layers 220, 222 may include a material that can be cured with peroxides. Additionally, the first and second elastomeric layers 220, 222 may be embodied as a substantially hydrophobic layer and/or a tacking bond layer. The first and second elastomeric layers 220, 222 may be co-molded or sequentially molded on the first fiber-reinforced layer 202 and the second fiber-reinforced layer 204, respectively, based on the type of application or material shrinkage rates, for instance.

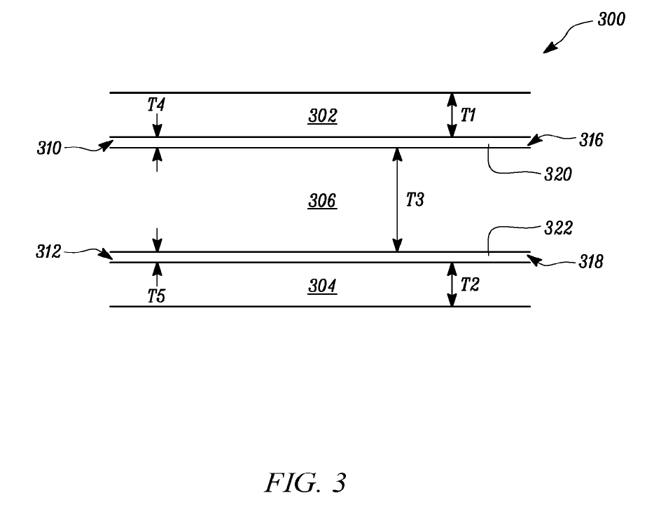

FIG. 3 illustrates yet another embodiment of the present disclosure. In this embodiment, a first elastomeric layer 320 of a composite structure 300 can be formed between a first fiber-reinforced layer 302 and a MDF cement layer 306. More particularly, the first elastomeric layer 320 can be formed between a second side 310 of the first fiber-reinforced layer 302 and a fifth side 316 of the MDF cement layer 306. Additionally or alternatively, a second elastomeric layer 322 of the composite structure 300 can be formed between a second fiber-reinforced layer 304 and the MDF cement layer 306. More particularly, the second elastomeric layer 322 can be formed between a third side 312 of the second fiber-reinforced layer 304 and a sixth side 318 of the MDF cement layer 306. The first and second elastomeric layers 320, 322 may be co-molded or sequentially molded on the first fiber-reinforced layer 302 and the second fiber-reinforced layer 304, respectively, based on the type of application or material shrinkage rates, for instance.

It should be noted that material and properties of the first and second elastomeric layers 320, 322 of the composite structure 300 may be similar to or the same as the material and properties of the first and second elastomeric layers 220, 222 of the composite structure 200. Further, material and properties of the first fiber-reinforced layers 202, 302, the second fiber-reinforced layers 204, 304, and the MDF cement layers 206, 306 of the composite structures 200, 300 may be similar to or the same as the material and properties of the first fiber-reinforced layer 102, the second fiber-reinforced layer 104, and the MDF cement layer 106 of the composite structure 100, respectively.

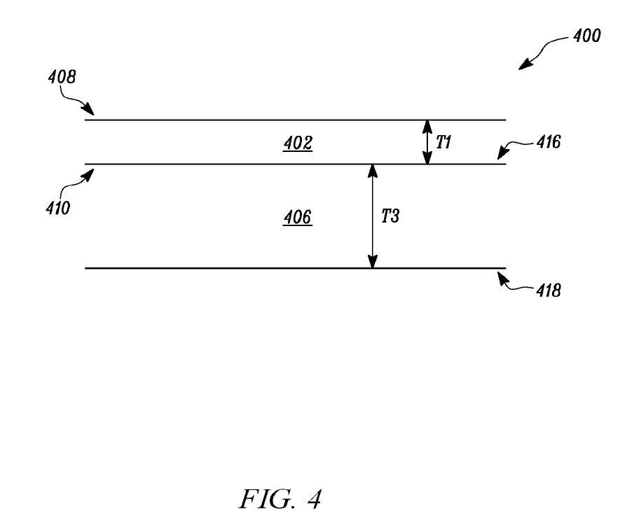

Referring now to FIG. 4, a diagrammatic representation of a composite structure 400 is illustrated. The composite structure 400 can include a fiber-reinforced layer 402 formed on or over a MDF cement layer 406. The fiber-reinforced layer 402 includes a first side 408 and a second side 410 opposite the first side 408. The first side 408 of the fiber-reinforced layer 402 can form a first external layer of the composite structure 400 or an overall structure including the composite structure 400. Further, the MDF cement layer 406 includes a bonding side 416 and an inner side 418 opposite the bonding side 416. The fiber-reinforced layer 402 can be formed on or over the bonding side 416 of the MDF cement layer 406. For example, as illustrated in FIG. 4, the fiber-reinforced layer 402 is directly on or contacts the MDF cement layer 406. Further, the inner side 418 of the MDF cement layer 406 can form a second external layer of the composite structure 400 or an overall structure including the composite structure 400. Material and properties of the fiber-reinforced layer 402 and the MDF cement layer 406 of the composite structure 400 may be similar to or the same as the material and properties of the fiber-reinforced layer 102 and the MDF cement layer 106, respectively, of the composite structure 100. The fiber-reinforced layer 402 includes a thickness “T1” that may be different, for instance thinner, than a thickness “T3” defined by the MDF cement layer 406.

The composite structure 400 may be embodied as a concurrently co-molded thermoset laminate structure or concurrently co-molded thermoset composite structure. In such an example, the fiber-reinforced material and the MDF cement material can be concurrently co-molded to form the fiber-reinforced layer 402 on or over the MDF cement layer 406. The fiber-reinforced layer 402 and the MDF cement layer 406 may be concurrently co-molded at temperatures between about 70° C. and 150° C.

In another example, the composite structure 400 may be sequentially molded, for instance, in light of different material shrinkage rates. In such an example, the MDF cement layer 406 of the composite structure 400 may be formed by molding the MDF cement material without the fiber-reinforced layer 402. The fiber-reinforced layer 402 can be over-molded on or over the MDF cement layer 406 after the MDF cement layer 406 is formed. In some situations, an adhesive may be used to bond the fiber-reinforced layer 402 with the MDF cement layer 406 of the composite structure 400.

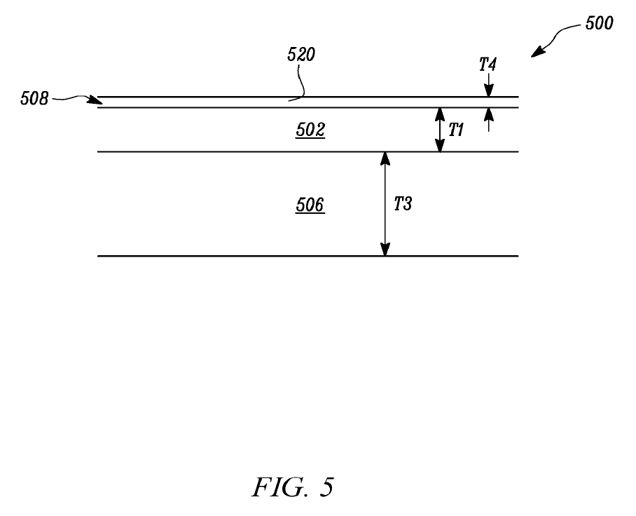

FIG. 5 illustrates a diagrammatic representation of a composite structure 500 having an elastomeric layer 520. The elastomeric layer 520 of the composite structure 500 can be located on a first side 508 of a fiber-reinforced layer 502. A thickness “T4” of the elastomeric layer 520 may be less than a thickness “T1” of the fiber-reinforced layer 502 and a thickness “T3” of a MDF cement layer 506 of the composite structure 500. The elastomeric layer 520 may be co-molded or sequentially molded to the first side 508 of the fiber-reinforced layer 502, based on the type of application or material shrinkage rates, for instance.

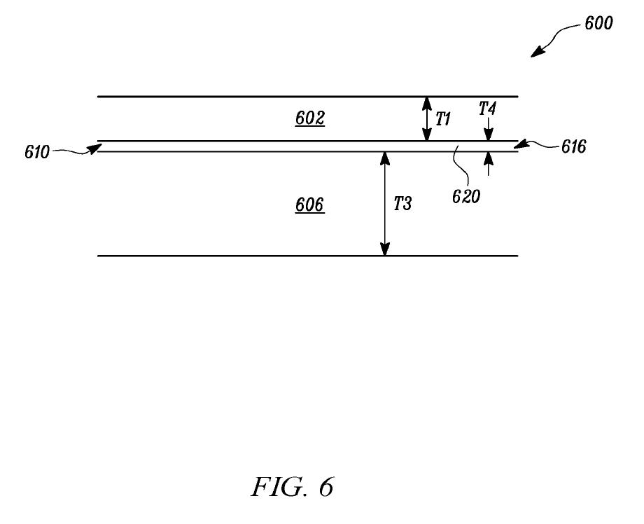

FIG. 6 illustrates yet another embodiment of the present disclosure. In this embodiment, a composite structure 600 includes an elastomeric layer 620. The elastomeric layer 620 is formed between a fiber-reinforced layer 602 and a MDF cement layer 606. More particularly, the elastomeric layer 620 is formed between a second side 610 of the fiber-reinforced layer 602 and a bonding side 616 of the MDF cement layer 606. A thickness “T4” of the elastomeric layer 620 may be less than a thickness “T1” of the fiber-reinforced layer 602 and a thickness “T3” of the MDF cement layer 606. The elastomeric layer 620 may be co-molded or sequentially molded between the fiber-reinforced layer 602 and the MDF cement layer 606, based on the type of application or material shrinkage rates, for instance.

It should be noted that material and properties of the elastomeric layers 520, 620 of the composite structures 500, 600 may be similar to or the same as the material and properties of the first elastomeric layer 220 of the composite structure 200. Further, material and properties of the fiber-reinforced layers 502, 602 and the MDF cement layers 506, 606 of the composite structures 500, 600 may be similar to or the same as the material and properties of the first fiber-reinforced layer 102 and the MDF cement layer 106, respectively, of the composite structure 100.

Of course, in one or more embodiments the composite structure may have one or more fiber-reinforced layers sandwiched by elastomeric layers. That is, generally speaking, the embodiments illustrated in FIG. 2 and FIG. 3 may be combined in whole or only on one side of the MDF cement layers 206, 306. Likewise, the embodiments in FIG. 5 and FIG. 6 may be combined in whole or only one side of the MDF cement layers 506, 606.

### Industrial Applicability

The present disclosure relates to multi-layered thermoset composite structures, such as composite structures 100, 200, 300, 400, 500, 600. The composite structures 100, 200, 300 can include a first fiber-reinforced layer 102, 202, 302 and a second fiber-reinforced layer 104, 204, 304, each of which providing improved tensile strength and impact toughness to the composite structure 100, 200, 300. In some examples, the first fiber-reinforced layer 102, 202, 302 and the second fiber-reinforced layer 104, 204, 304 include are molded using a fiber-reinforced composite prepreg material. The prepreg material may include a continuous or discontinuous fiber-based material that already includes the resin system. Use of the prepreg material can eliminate handling of liquid resins as the prepreg material is already pre-impregnated with the resin system. Further, the prepreg material can have a relatively more flexible matrix in the fiber-reinforced layers as compared to a MDF layer, for instance, and also provide a benefit of flexibility in the first fiber-reinforced layer 102, 202, 302 and the second fiber-reinforced layer 104, 204, 304.

The composite structure 100, 200, 300 can include a core MDF cement layer 106, 206, 306 that provides relatively high shear strength and compressive strength. The MDF material used for the MDF cement layer 106, 206, 306 can maximize stiffness of a panel or beam construction, particularly where weight of building material is not a concern or not a primary concern. According to some embodiments of the present disclosure, the first fiber-reinforced layer 102, 202, 302 and the second fiber-reinforced layer 104, 204, 304 may be bonded with the MDF cement layer 106, 206, 306 without use of a separate adhesive therebetween.

Further, the composite structures 100, 200, 300 disclosed herein can be manufactured using concurrent co-molding. Concurrent co-molding may be used since both SMC and MDF cement materials are formulated to cure by thermosetting type reactions, and both materials can be cured at similar or same temperatures, for example, between about 70° C. and 150° C.

In some examples, the composite structures 100, 200, 300, 400, 500, 600 may be sequentially molded, for instance, to reduce or eliminate inter-laminar shear stress caused by different shrink rates, and to reduce or eliminate warping, for instance, when only one core layer and one outer skin are to be molded.

In some embodiments, the composite structure 100, 200, 300 includes the elastomeric layers 220, 222, 320, 322 that can be co-molded or sequentially molded to the first fiber-reinforced layer 102, 202, 302 and the second fiber-reinforced layer 104, 204, 304. The elastomeric layers 220, 222 can create a scuff-resistant skin, thereby providing additional toughness, impact resistance, and smoothness to the composite structure 200. Further, the elastomeric layers 220, 222 can protect the fibers of the underlying skin layers 202, 204.

The above description is provided in reference to the multi-layer composite structures 100, 200, 300. However, the description is equally applicable to the composite structures 400, 500, 600 having the fiber-reinforced layers 402, 502, 602 and the MDF cement layers 406, 506, 606, without any limitations.

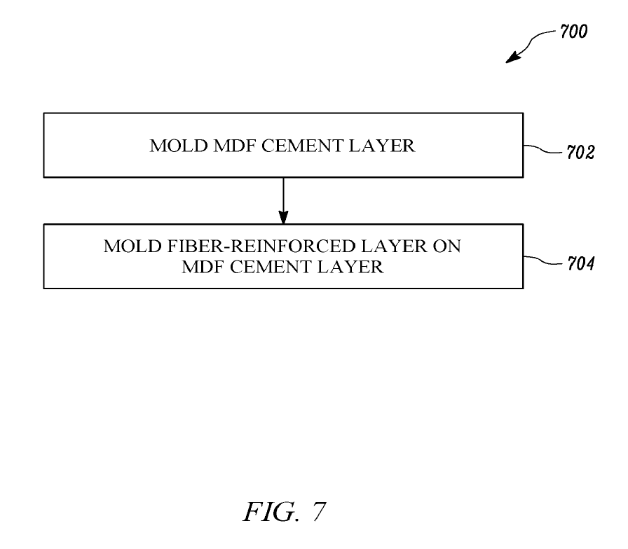

FIG. 7 is a flowchart for a method 700 of molding a thermoset composite structure, such as thermoset composite structures 100, 200, 300, 400, 500, 600. At step 702, a MDF cement layer is molded, such as MDF cement layer 106, 206, 306, 406, 506, 606. At step 704, a first fiber-reinforced layer, such as fiber-reinforced layers 102, 202, 302, 402, 502, 602, is molded on or over the MDF cement layer 106, 206, 306, 406, 506, 606. The first fiber-reinforced layer 102, 202, 302, 402, 502, 602 can have a tensile strength greater than or equal to 400 MPa. In one example, MDF cement material can be molded to form the MDF cement layer 106, 206, 306, 406, 506, 606, after which a first fiber-reinforced composite prepreg material can be over-molded to form the first fiber-reinforced layer 102, 202, 302, 402, 502, 602 on or over the MDF cement layer 106, 206, 306, 406, 506, 606. In another example, the MDF cement material and the first prepreg material may be co-molded to form the first prepreg layer 102, 202, 302, 402, 502, 602 on or over the MDF cement layer 106, 206, 306, 406, 506, 606.

In some embodiments, the composite structure 100, 200, 300 also includes a second fiber-reinforced layer, such as second fiber-reinforced layers 104, 204, 304. The second prepreg layer 104, 204, 304 is formed on or over the MDF cement layer 106, 206, 306 on the side of the MDF cement layer 106, 206, 306 opposite the side on or over which the first fiber-reinforced layer 102, 202, 302 is formed. More particularly, the second fiber-reinforced layer 104, 204, 304 is formed on or over the sixth side 118, 218, 318 of the MDF cement layer 106, 206, 306.

The composite structure 200, 300 can also include first and/or second elastomeric layers, such as elastomeric layers 220, 222, 320, 322, 520, 522, 620, 622. In one example, the first elastomeric layer 220, 520 may be formed on or over the first fiber-reinforced layer 202, 502. In another example, the elastomeric layer 320, 620 may be formed between the first fiber-reinforced layer 302, 602 and the MDF cement layer 306, 606. Further, the second elastomeric layer 222 may be formed on or over the second fiber-reinforced layer 204. In another example, the elastomeric layer 322 may be formed between the second fiber-reinforced layer 304 and the MDF cement layer 306.

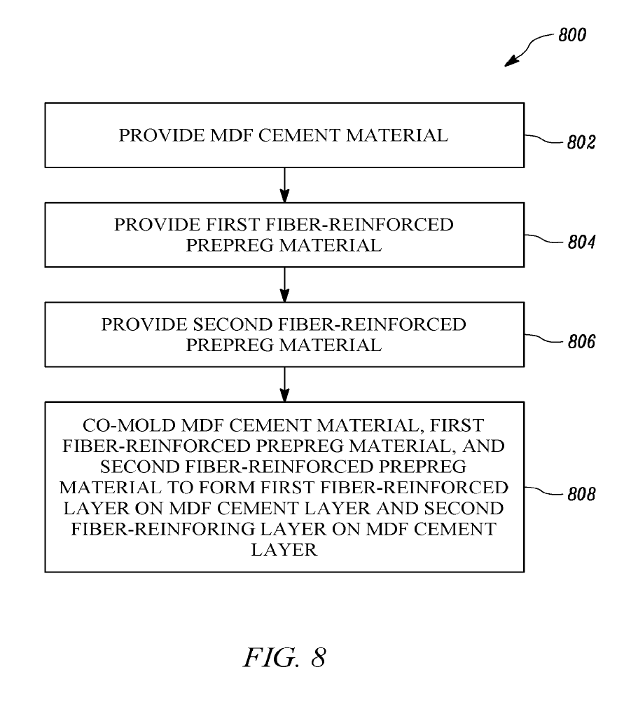

FIG. 8 is a flowchart for a method 800 of co-molding components to form a thermoset composite structure, such as composite structure 100. At step 802, the MDF cement material is provided. At step 804, the first fiber-reinforced prepreg material is provided. At step 806, the second fiber-reinforced prepreg material is provided. At step 808, the MDF cement material, the first fiber-reinforced prepreg material, and the second fiber-reinforced prepreg material are co-molded to form the first fiber-reinforced layer 102 on or over the MDF cement layer 106 and the second fiber-reinforced layer 104 on or over the MDF cement layer 106. Although, the method 800 is explained with reference to three layers, the method 800 is equally applicable to other composite structures, such as composite structures 200, 300, 400, 500, 600, without limiting the scope of the present disclosure. For example, a second fiber-reinforced prepreg material may not be provided at all, or may not be provided to be co-molded with the MDF cement material and the first fiber-reinforced prepreg material, instead provided later and molded on or over the MDF cement layer 106 in a subsequent molding step.

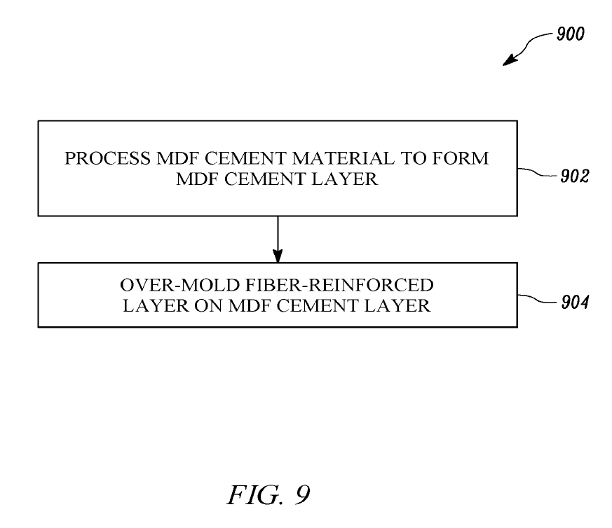

FIG. 9 is a flowchart for a method 900 of sequentially molding components to form a composite structure, such as composite structure 400. At step 902, the MDF cement material is processed to form a MDF cement layer, such as MDF cement layer 406. At step 904, a fiber-reinforced prepreg material is provided, and the first fiber-reinforced layer 402 is over-molded on or over the MDF cement layer 406. Although, the method 900 is explained with reference to two layers, the method 900 is equally applicable to other composite structures 100, 200, 300, 500, 600, without limiting the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A concurrently co-molded thermoset laminate structure comprising:
a first fiber-reinforced composite layer having a first side and a second side opposite the first side;
a second fiber-reinforced composite layer having a third side and a fourth side opposite the third side; and
a Macro-Defect-Free (MDF) cement layer having a fifth side contacting the second side of the first fiber-reinforced composite layer and a sixth side opposite the fifth side contacting the third side of the second fiber-reinforced composite layer.

2. The laminate structure of claim 1, further comprising an elastomeric layer located on at least one of the first side of the first fiber-reinforced composite layer and the fourth side of the second fiber-reinforced composite layer.

3. The laminate structure of claim 1, wherein the MDF cement layer is thicker than the first and second fiber-reinforced composite layers.

4. The laminate structure of claim 1, wherein one of the first side of the first fiber-reinforced composite layer and the fourth side of the second fiber-reinforced composite layer forms an outermost layer of the laminate structure as an external surface.

5. The laminate structure of claim 1, wherein the first fiber-reinforced layer and the second fiber-reinforced layer are fiber-reinforced Sheet Molding Compound (SMC) composite layers.

6. The laminate structure of claim 1, wherein at least one of the first and second fiber-reinforced composite layers have a tensile strength of 300 MPa or greater.

7. A structural laminate comprising:
a first fiber-reinforced layer with a first side and a second side opposite the first side, the first fiber-reinforced layer having a tensile strength greater than or equal to 400 MPa;
a second fiber-reinforced layer with a third side and a fourth side opposite the third side, the second fiber-reinforced layer having a tensile strength greater than or equal to 400 MPa; and
a third layer with a fifth side and a sixth side opposite the fifth side interposed between said first and second fiber-reinforced layers,
wherein the third layer has a compressive strength greater than or equal to 200 MPa and a compressive modulus greater than or equal to 30 GPa.

8. The structural laminate of claim 7, further comprising an elastomeric layer located on at least one of the first side of the first fiber-reinforced layer and the fourth side of the second fiber-reinforced layer.

9. The structural laminate of claim 7, further comprising an elastomeric layer located between at least one of the second side of the first fiber-reinforced layer and the fifth side of the third layer, and the third side of the second fiber-reinforced layer and the sixth side of the third layer.

10. The structural laminate of claim 7, wherein the third layer is a Macro-Defect-Free (MDF) cement layer.

11. The structural laminate of claim 7, wherein the second side of the first fiber-reinforced layer contacts the fifth side of the third layer, and the third side of the second fiber-reinforced layer contacts the sixth side of the third layer.

12. The structural laminate of claim 7, wherein at least one of the first and second fiber-reinforced layers is molded after the third layer is formed.

13. The structural laminate of claim 7, wherein at least one of the first and second fiber-reinforced layers is molded concurrently with the third layer.

14. A method of forming a thermoset composite structure comprising:
molding a Macro-Defect-Free (MDF) cement material to form a MDF cement layer; and
molding a first fiber-reinforced prepreg material to form a first fiber-reinforced layer on the MDF layer,
wherein the first fiber-reinforced layer has a tensile strength greater than or equal to 400 MPa.

15. The method of claim 14, wherein said molding includes co-molding the MDF cement material and the first fiber-reinforced prepreg material to form the first fiber-reinforced layer on the MDF cement layer.

16. The method of claim 14, further comprising:
molding a second fiber-reinforced prepreg material to form a second fiber-reinforced layer on the MDF cement layer on a side of the MDF cement layer opposite the side on which the first fiber-reinforced layer is molded.

17. The method of claim 14, further comprising:
providing an elastomeric layer on the first fiber-reinforced layer.

18. The method of claim 14, further comprising:
providing an elastomeric layer between the first fiber-reinforced layer and the MDF cement layer.

19. The method of claim 14, wherein the first fiber-reinforced layer is one of a discontinuous-fiber composite layer and a continuous-fiber composite layer.

20. The method of claim 14, wherein the MDF cement layer has a compressive strength greater than or equal to 200 MPa and a compressive modulus greater than or equal to 30 GPa.
